(19) United States
(12) Patent Application Publication
(10) Pub. No.: US 2025/0225905 A1
(43) Pub. Date: Jul. 10, 2025

(54) Method for Controlling Subpixel Luminance, and Display Screen Implementing the Same

(71) Applicant: Hung-Cheng Kuo, Hsinchu City (TW)

(72) Inventor: Hung-Cheng Kuo, Hsinchu City (TW)

(21) Appl. No.: 18/405,554

(22) Filed: Jan. 5, 2024

(51) Int. Cl. G09G 3/20

(52) U.S. Cl. CPC G09G 3/2074; G09G 2300/0842; G09G 2310/0286; G09G 2320/0626

(57) ABSTRACT

A method is provided for controlling subpixel luminance of a display screen. A driver circuit performs a first PWM on a subpixel based on a grayscale value of the subpixel when the grayscale value falls within a first grayscale range. When the first PWM is performed, the subpixel is driven to emit light at a first luminance when the subpixel is turned on. The driver circuit performs a second PWM on the subpixel based on the grayscale value when the grayscale value falls within a second grayscale range that is separate from and lower than the first grayscale range. When the second PWM is performed, the subpixel is driven to emit light at a second luminance when the subpixel is turned on. The second luminance is 2^{-N} times the first luminance, and N is a positive integer.

### BACKGROUND OF THE DISCLOSURE

### Field of the Disclosure

The disclosure relates to a display screen, and more particularly to a method for controlling subpixel luminance of a display screen.

### Description of Related Art

A display screen includes a plurality of subpixels of different colors (e.g., red, green, blue colors, etc.) to display color images. A conventional way to drive a subpixel to emit light is direct current driving or analog driving, which adjusts magnitudes of driving current or voltage based on a grayscale value of the subpixel that is received from an image source (e.g., a display chip), making the luminance of light emitted by the subpixel correspond to the grayscale value. However, when the grayscale value is at a low gray level, the corresponding magnitude of the driving current or voltage would be so small that generating the driving current or voltage that precisely corresponds to the grayscale value would be very difficult. As a result, the magnitudes of the resultant driving current or voltage for small gray levels are usually imprecise, resulting in luminance deviation, which may affect color presentation on the display screen.

Another conventional way to drive a subpixel to emit light is pulse width modulation (PWM), which turns the subpixel on and off at a high frequency so that a viewer will not notice the flashing of the subpixel but will perceive a constant light emission from the subpixel. In this approach, the subpixel is driven to emit light with a fixed high luminance when being turned on, and a pulse width of a PWM driving signal is adjusted based on the grayscale value of the subpixel to make a perceptual luminance of the subpixel correspond to the grayscale value. At a given frequency of the PWM driving signal, the pulse width, which corresponds to a duty cycle of the PWM driving signal, is theoretically proportional to the perceptual luminance that equals the fixed high luminance multiplied by the duty cycle.

In the PWM approach, although the viewer is not aware of the flashing of the subpixel because of persistence of vision, the viewer's eyes are actually suffering from the flashing light with high intensity. Furthermore, in practice, the PWM driving signal will not be a perfect square wave, and will inevitably have distortions at its rising edge and falling edge. The distortions may not present significant adverse effects when the pulse width is large, but are likely to cause luminance deviation when the pulse width is small, which may occur when the grayscale value is small (i.e., the subpixel is desired to have low luminance) and/or a frequency of the PWM driving signal is high, and thus affect accuracy in color presentation by the display screen.

### SUMMARY OF THE DISCLOSURE

Therefore, an object of the disclosure is to provide a method for controlling subpixel luminance of a display screen, where the method can alleviate at least one of the drawbacks of the prior art.

According to the disclosure, the method includes: receiving a grayscale value of a first subpixel of the display screen; performing a first pulse width modulation (PWM) on the first subpixel based on the grayscale value when the grayscale value falls within a first grayscale range, where the first subpixel is driven to emit light at a first luminance when the first subpixel is turned on during the performing of the first PWM; and performing a second PWM on the first subpixel based on the grayscale value when the grayscale value falls within a second grayscale range that is separate from and lower than the first grayscale range, where the first subpixel is driven to emit light at a second luminance when the first subpixel is turned on during the performing of the second PWM, and the second luminance is 2^{-N} times the first luminance, N being a positive integer.

Another object of the disclosure is to provide a display screen that can alleviate at least one of the drawbacks of the prior art.

According to the disclosure, the display screen includes a screen substrate, a first subpixel driving memory unit, a second subpixel driving memory unit, a grayscale conversion memory unit, and a driver circuit. The screen substrate is formed with a plurality of subpixels, one of which is a first subpixel. The first subpixel driving memory unit is mounted on the screen substrate, and stores first subpixel driving data that include a datum for driving the first subpixel to emit light at a first luminance. The second subpixel driving memory unit is mounted on the screen substrate, and stores second subpixel driving data that include a datum for driving the first subpixel to emit light at a second luminance that is 2^{-N} times the first luminance, where N is a positive integer. The grayscale conversion memory unit is mounted on the screen substrate, and stores a predetermined relationship between grayscale and pulse width for pulse width modulation (PWM). The driver circuit is mounted on the screen substrate, is electrically connected to the subpixels, the first subpixel driving memory unit, the second subpixel driving memory unit and the grayscale conversion memory unit, and is disposed to receive a grayscale value of the first subpixel. The driver circuit is configured to, when the grayscale value falls within a first grayscale range, perform a first PWM on the first subpixel based on the grayscale value and the predetermined relationship between grayscale and pulse width for PWM, where the first subpixel is driven by the driver circuit to emit light at the first luminance based on the first subpixel driving data when the first subpixel is turned on during the performing of the first PWM. The driver circuit is configured to, when the grayscale value falls within a second grayscale range that is separate from and lower than the first grayscale range, perform a second PWM on the first subpixel based on the grayscale value and the predetermined relationship between grayscale and pulse width for PWM, where the first subpixel is driven by the driver circuit to emit light at the second luminance based on the second subpixel driving data when the first subpixel is turned on during the performing of the second PWM.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a first implementation of an embodiment of a display screen according to the disclosure.

FIG. 2 is a plot illustrating a predetermined relationship between grayscale and pulse width for PWM, which is adapted to the first implementation.

FIG. 3 is a flow chart illustrating an embodiment of a method for controlling subpixel luminance of the display screen of the first implementation.

FIG. 4 is a block diagram illustrating a second implementation of the embodiment of the display screen according to the disclosure.

FIG. 5 is a plot illustrating a predetermined relationship between grayscale and pulse width for PWM, which is adapted to the second implementation.

FIG. 6 is a flow chart illustrating an embodiment of a method for controlling subpixel luminance of a display screen of the second implementation.

FIG. 7 is a flow chart illustrating a variation of the embodiment of a method for controlling subpixel luminance of the display screen of the second implementation.

FIG. 8 is a block diagram illustrating a third implementation of the embodiment of the display screen according to the disclosure.

FIG. 9 is a plot illustrating a relationship between grayscale and desired perceptual luminance, which is adapted to the third implementation

### DESCRIPTION OF NON-LIMITING EMBODIMENTS OF THE DISCLOSURE

Before the disclosure is described in greater detail, it should be noted that where considered appropriate, reference numerals or terminal portions of reference numerals have been repeated among the figures to indicate corresponding or analogous elements, which may optionally have similar characteristics.

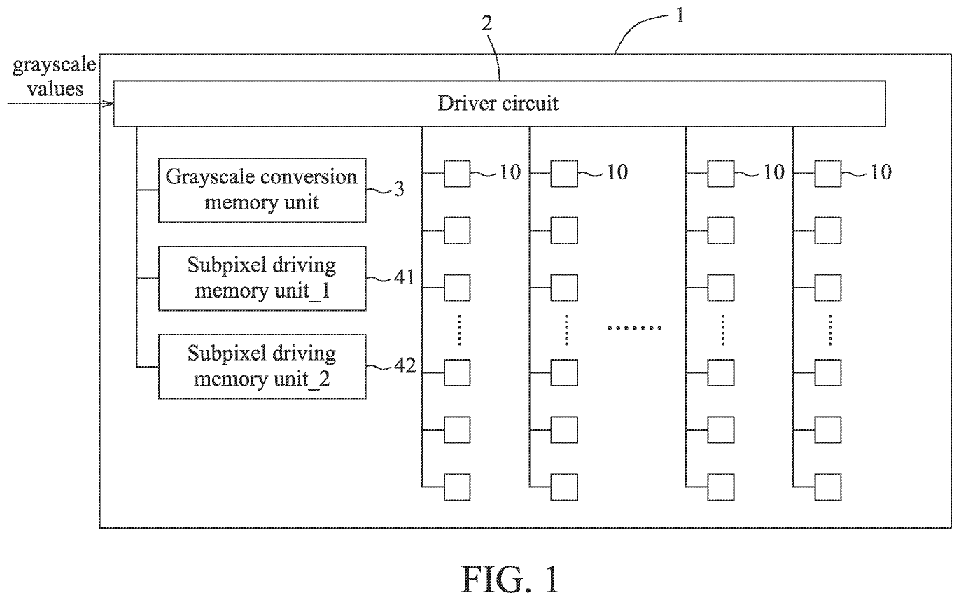

Referring to FIGS. 1, 4 and 8, an embodiment of a display screen according to this disclosure is shown to include a screen substrate 1 (e.g., a glass substrate, a plastic substrate, a semiconductor substrate, etc.) that is formed with a plurality of subpixels 10, and to further include a driver circuit 2, a grayscale conversion memory unit 3, and multiple subpixel driving memory units that are mounted on the screen substrate 1. In a first implementation as shown in FIG. 1, the subpixel driving memory units are exemplified to include a first subpixel driving memory unit 41 and a second subpixel driving memory unit 42, but this disclosure is not limited to such. In other implementations, the display screen may include three or more subpixel driving memory units.

The driver circuit 2 is electrically connected to the subpixels 10, is disposed to receive grayscale values respectively of the subpixels 10 from an image source (not shown), and is configured to drive the subpixels 10 to emit light based on the grayscale values. In practice, the driver circuit 2 may include a timing controller, a pulse width modulation (PWM) controller, gate drivers, source drivers, registers, logic gate, other suitable circuit components, or any combination thereof, which should be familiar to those skilled in the art, and thus will not be described in further detail for the sake of brevity.

The grayscale conversion memory unit 3 and the subpixel driving memory units 41, 42 are electrically connected to the driver circuit 2, and may be realized using one or more memory chips (e.g., flash memory chip(s), read-only memory chip(s), etc.). For example, a single memory chip may be configured to implement one of the memory units 3, 41, 42, or implement more than one of the memory units 3, 41, 42 in different sections thereof, and this disclosure is not limited in this respect.

In this embodiment, the display screen is configured to define multiple grayscale ranges that are separate from each other, and at least two of the grayscale ranges respectively correspond to different PWMs for controlling dimming of the subpixels 10. The grayscale conversion memory unit 3 stores a predetermined relationship between grayscale and pulse width for PWM, which is used to convert a grayscale value to a reference pulse width. The dimming of each subpixel 10 is controlled using a respective PWM signal. A pulse width of the PWM signal is proportional to a duty cycle of the PWM signal, and is thus proportional to a perceptual or average luminance of the corresponding subpixel 10. Therefore, the relationship between grayscale and pulse width can be deemed as a relationship between grayscale and desired perceptual luminance. Said at least two of the grayscale ranges that respectively correspond to different PWMs include a first grayscale range, and a second grayscale range that is separate from and lower than the first grayscale range (namely, an upper limit of the second grayscale range is smaller than a lower limit of the first grayscale range), where an upper limit of the first grayscale range corresponds to a first desired perceptual luminance, the upper limit of the second grayscale range corresponds to a second desired perceptual luminance that is about 2^{-N} times the first desired perceptual luminance, and N is a positive integer. In order to make a subpixel 10 have the second desired perceptual luminance, a conventional approach is to reduce the pulse width of the corresponding PWM signal to about 2^{-N} times the pulse width that is used to make the subpixel 10 have the first desired perceptual luminance. However, this embodiment employs the same pulse width as is used for the first desired perceptual luminance to make the subpixel 10 have the second desired perceptual luminance, by reducing an actual turn-on luminance of the subpixel 10 to about 2^{-N} times an actual turn-on luminance of the subpixel 10 when driven to provide the first desired perceptual luminance.

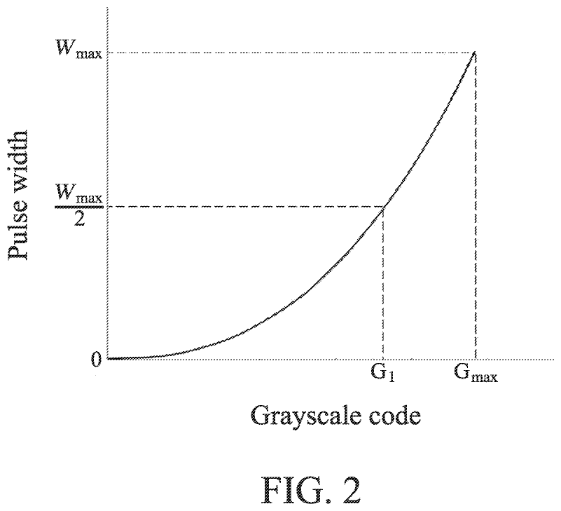

In practice, the reference pulse width obtained from the predetermined relationship between grayscale and pulse width may be represented using a binary code (referred to as “binary pulse code” hereinafter) that is composed of multiple bits. In this implementation, the first grayscale range is defined such that, for each binary pulse code that corresponds to a grayscale code in the first grayscale range, each of the leftmost M number of bit(s) of the binary pulse code is equal to binary 0, where M is a predetermined integer not smaller than zero; and the second grayscale range is defined such that, for each binary pulse code that corresponds to a grayscale code in the second grayscale range, each of the leftmost (M+N) number of bit(s) of the binary pulse code is equal to binary 0. Such an arrangement is made to facilitate subsequent operations of PWM, which will be described later. In some examples, the first grayscale range is further defined such that, for the binary pulse code that corresponds to the upper limit of the first grayscale range (i.e., the greatest grayscale code in the first grayscale range, which is Gₘₐₓ in FIG. 2), each of those bits of the binary pulse code other than the leftmost M number of bit(s) of the binary pulse code is equal to binary 1; and the second grayscale range is further defined such that, for the binary pulse code that corresponds to the upper limit of the second grayscale range (i.e., the greatest grayscale code in the second grayscale range, which is G₁ in FIG. 2), each of those bits of the binary pulse code other than the leftmost (M+N) number of bit(s) of the binary pulse code is equal to binary 1.

Further referring to FIG. 2, an exemplary predetermined relationship between grayscale and pulse width for PWM is shown to be adapted to the first implementation. The display screen in this example defines the first grayscale range as being from (G₁+1) to Gₘₐₓ, and the second grayscale range as being from 0 to G₁, where Gₘₐₓ is a grayscale code that corresponds to a maximum pulse width Wₘₐₓ representing a maximum desired perceptual luminance of the subpixels 10, and G₁ is a grayscale code that corresponds to approximately half (i.e., 2⁻¹ times) the maximum pulse width Wₘₐₓ. In this example, M=0 and N=1. Assuming that the display screen is an 8-bit display screen of which the grayscale codes range from 0 to 255 in decimal and assuming that the pulse width is represented using 10-bit binary pulse codes which range from 0 to 1023 in decimal, the grayscale code Gₘₐₓ is 255 and the corresponding pulse width Wₘₐₓ is 1023 (represented by 1111111111 in binary, which corresponds to a duty cycle of 100% or approximately 100%), and the pulse width corresponding to the grayscale code G₁ may be 511 (represented by 0111111111 in binary, which corresponds to a duty cycle of approximately 50%).

The first subpixel driving memory unit 41 stores first subpixel driving data that include, for each of the subpixels 10, a datum such as a voltage value or a current value for driving the subpixel 10 to emit light at a first luminance (actual turn-on luminance, as performed in analog driving).

The second subpixel driving memory unit 42 stores second subpixel driving data that include, for each of the subpixels 10, a datum such as a voltage value or a current value for driving the subpixel 10 to emit light at a second luminance that is 2^{-N} times the first luminance.

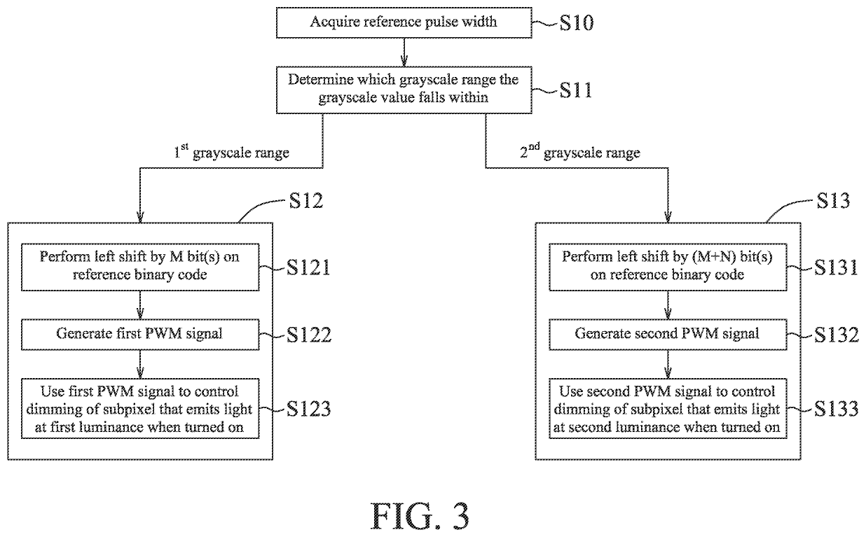

Further referring to FIG. 3, an embodiment of a method for controlling subpixel luminance of the display screen of the first implementation is implemented by the driver circuit 2. The method is applied to each of the subpixels 10, but is described with respect to a single subpixel 10 hereinafter for the sake of readability.

After receiving a grayscale value of a subpixel 10, the driver circuit 2 acquires a reference pulse width (step S10) based on the grayscale value and the predetermined relationship between grayscale and pulse width for PWM. In one example, the reference pulse width may be acquired by mapping the grayscale value to a reference binary code using the predetermined relationship between grayscale and pulse width for PWM, where the reference pulse width corresponds to the reference binary code, which is composed of a plurality of bits. Taking FIG. 2 as an example, when the grayscale value is equal to Gₘₐₓ (e.g., 11111111 in binary), the grayscale value would be mapped to a binary pulse code representing Wₘₐₓ (e.g., 1111111111 in binary), and the reference binary code is thus obtained; and when the grayscale value is equal to G₁, the grayscale value would be mapped to a binary pulse code representing half of Wₘₐₓ (e.g., 0111111111 in binary), and the reference binary code is thus obtained.

In step S11, the driver circuit 2 determines which one of the grayscale ranges the grayscale value of the subpixel 10 falls within. The flow goes to step S12 when the grayscale value falls within the first grayscale range, and goes to step S13 when the grayscale value falls within the second grayscale range. It is noted that, in other embodiments, step S10 and step S11 may be performed simultaneously, or in a different order from that depicted in FIG. 3, and this disclosure is not limited in this respect.

In step S12, the driver circuit 2 performs a first PWM on the subpixel 10 based on the grayscale value. When performing the first PWM, the driver circuit 2 performs a left shift (e.g., a logical left shift or an arithmetic left shift) by M bit position(s) on the reference binary code (sub-step S121) to obtain a first pulse width code that is 2M times the reference binary code, and then the driver circuit 2 generates a first PWM signal that has a pulse width corresponding to the first pulse width code and equaling 2M times the reference pulse width (sub-step S122). The driver circuit 2 sends the first PWM signal to the subpixel 10 to control dimming of the subpixel 10, while the subpixel 10 is being driven by the driver circuit 2 to emit light at the first luminance based on the first subpixel driving data when the subpixel 10 is turned on by the first PWM signal (sub-step S123), where the first luminance is 2-M times the maximum desired perceptual luminance. Since the grayscale value falls within the first grayscale range, the leftmost M bit(s) of the reference binary code is/are all binary 0, and thus the first pulse width code, which is 2M times the reference binary code, can be obtained by simply shifting the other bits of the reference binary code to the left by M bit position(s), thereby minimizing the complexity of circuit design. The combination of the first luminance and the pulse width of the first PWM signal achieves the same perceptual luminance as would be obtained by the combination of the maximum desired perceptual luminance and the reference pulse width, and the adverse effects resulting from the distortions at rising and falling edges of the PWM signal can be alleviated when M>0 because the pulse width is increased to 2M times the reference pulse width. In the example as shown in FIG. 2, M=0, so the first luminance is equal to the maximum desired perceptual luminance.

In step S13, the driver circuit 2 performs a second PWM on the subpixel 10 based on the grayscale value. When performing the second PWM, the driver circuit 2 performs a left shift by (M+N) bit position(s) on the reference binary code (sub-step S131) to obtain a second pulse width code that is 2^{(M+N)} times the reference binary code, and then the driver circuit 2 generates a second PWM signal that has a pulse width corresponding to the second pulse width code and equaling 2^{(M+N)} times the reference pulse width (sub-step S132). The driver circuit 2 sends the second PWM signal to the subpixel 10 to control dimming of the subpixel 10, while the subpixel 10 is being driven by the driver circuit 2 to emit light at the second luminance based on the second subpixel driving data when the subpixel 10 is turned on by the second PWM signal (sub-step S133). Since the grayscale value falls within the second grayscale range, the leftmost (M+N) bit(s) of the reference binary code is/are all binary 0, and thus the second pulse width code, which is 2^{(M+N)} times the reference binary code, can be obtained by simply shifting the other bits of the reference binary code to the left by (M+N) bit position(s), thereby minimizing the complexity of circuit design. In this implementation, when the grayscale value is small (i.e., falling within the second grayscale), the combination of the second luminance and the pulse width of the second PWM signal achieves the same perceptual luminance as would be obtained by the combination of the maximum desired perceptual luminance and the reference pulse width. Meanwhile, the adverse effects resulting from the distortions at rising and falling edges of the PWM signal can be alleviated because the pulse width is increased to 2^{(M+N)} times the reference pulse width, while the diminished luminance (i.e., the second luminance that is 2^{-N} times the first luminance) reduces harm caused to the eyes of the viewer. Furthermore, since both of the first PWM and the second PWM use the same predetermined relationship between grayscale and pulse width for PWM, required memory capacity can be minimized. In the example as shown in FIG. 2, N=1, so the second luminance is half the first luminance.

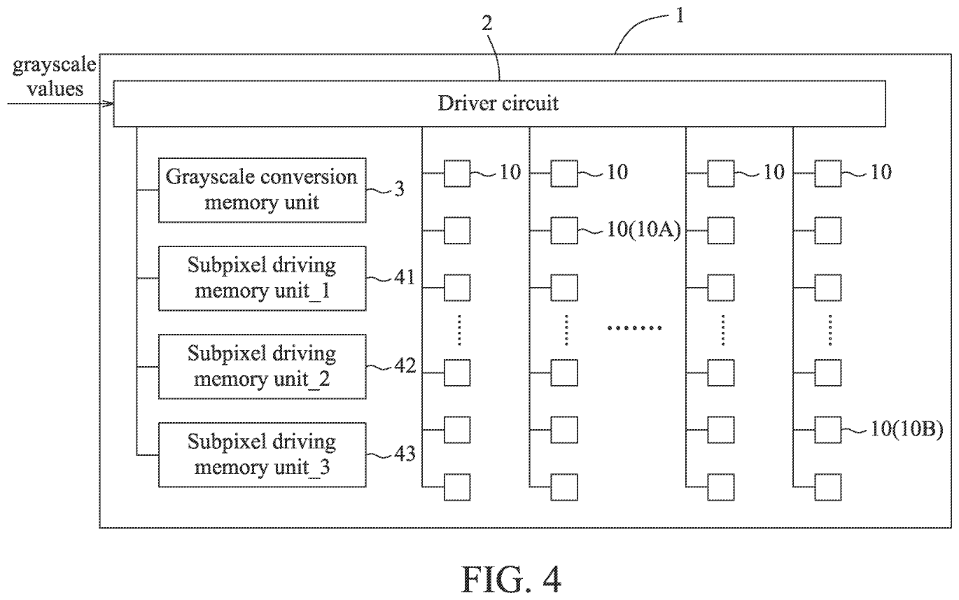

FIG. 4 illustrates a second implementation of the embodiment of the display screen that is similar to the first implementation. The second implementation differs from the first implementation in that the subpixel driving memory units further include a third subpixel driving memory unit 43, and that said at least two of the grayscale ranges that respectively correspond to different PWMs further include a third grayscale range that is separate from and lower than the second grayscale range (namely, an upper limit of the third grayscale range is smaller than a lower limit of the second grayscale range), where the upper limit of the third grayscale range corresponds to a third desired perceptual luminance that is about 2^{-P} times the second desired perceptual luminance, and P is a positive integer.

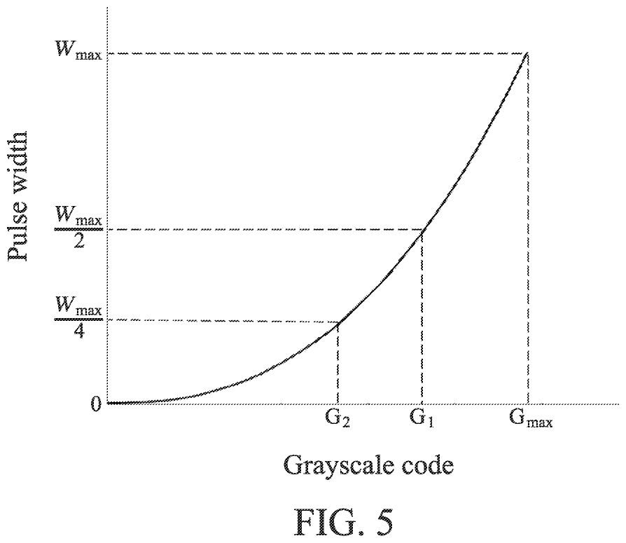

Further referring to FIG. 5, an exemplary predetermined relationship between grayscale and pulse width for PWM is shown to be adapted to the second implementation. The display screen in this example defines the first grayscale range as being from (G₁+1) to Gₘₐₓ, the second grayscale range as being from (G₂+1) to G₁, and the third grayscale range as being from 0 to G₂, where Gₘₐₓ is a grayscale code that corresponds to the maximum pulse width Wₘₐₓ, G₁ is a grayscale code that corresponds to approximately half (i.e., 2⁻¹ times) the maximum pulse width Wₘₐₓ, G₂ is a grayscale code that corresponds to approximately a quarter (i.e., 2-2 times) of the maximum pulse width Wₘₐₓ, and the third grayscale range is defined such that, for each binary pulse code that corresponds to a grayscale code in the third grayscale range, each of the leftmost (M+N+P) number of bits of the binary pulse code is equal to binary 0. In the example as shown in FIGS. 5, M=0, N=1 and P=1. In some examples, the third grayscale range is further defined such that, for the binary pulse code that corresponds to the upper limit of the third grayscale range (i.e., the greatest grayscale code in the third grayscale range, which is G₂ in FIG. 5), each of those bits of the binary pulse code other than the leftmost (M+N+P) number of bits of the binary pulse code is equal to binary 1. For instance, assuming that the display screen is an 8-bit display screen of which the grayscale codes range from 0 to 255 in decimal and assuming that the pulse width is represented using 10-bit binary pulse codes which range from 0 to 1023 in decimal, the pulse width corresponding to the grayscale code G₂ may be 255 (represented by 0011111111 in binary, which corresponds to a duty cycle of approximately 25%).

The third subpixel driving memory unit 43 stores third subpixel driving data that include, for each of the subpixels 10, a datum such as a voltage value or a current value for driving the subpixel 10 to emit light at a third luminance that is 2^{-P} times the second luminance.

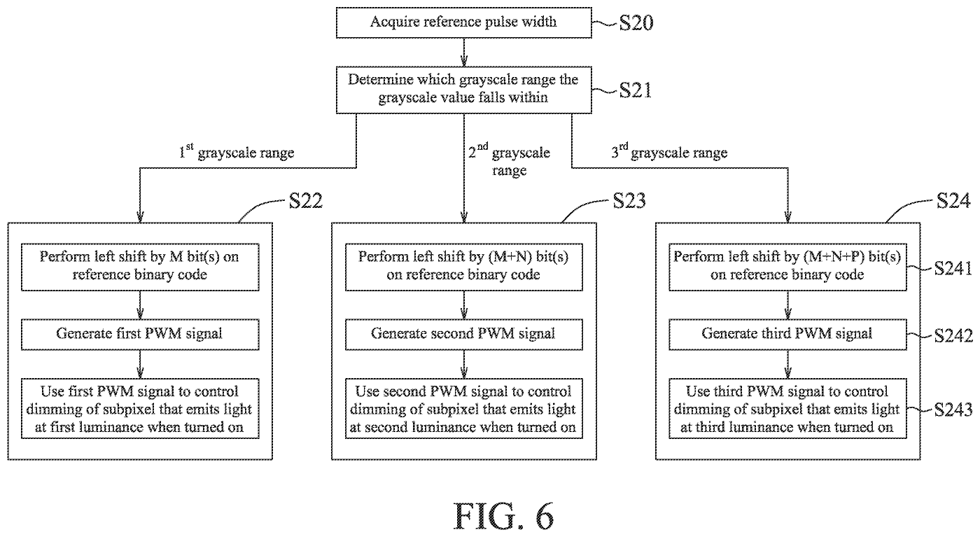

Further referring to FIG. 6, an embodiment of a method for controlling subpixel luminance of the display screen of the second implementation is implemented by the driver circuit 2. The method is applied to each of the subpixels 10, but is described with respect to a single subpixel 10 hereinafter for the sake of readability. Since steps S20, S22 and S23 are respectively the same as steps S10, S12 and S13 in FIG. 3, details thereof are not repeated herein for the sake of brevity.

In step S21, the driver circuit 2 determines which one of the grayscale ranges the grayscale value of the subpixel 10 falls within. The flow goes to step S22 when the grayscale value falls within the first grayscale range, goes to step S23 when the grayscale value falls within the second grayscale range, and goes to step S24 when the grayscale value falls within the third grayscale range.

In step S24, the driver circuit 2 performs a third PWM on the subpixel 10 based on the grayscale value. When performing the third PWM, the driver circuit 2 performs a left shift by (M+N+P) bit positions on the reference binary code (sub-step S241) to obtain a third pulse width code that is 2^{(M+N+P)} times the reference binary code, and then the driver circuit 2 generates a third PWM signal that has a pulse width corresponding to the third pulse width code and equaling 2^{(M+N+P)} times the reference pulse width (sub-step S242). The driver circuit 2 sends the third PWM signal to the subpixel 10 to control dimming of the subpixel 10, while the subpixel 10 is being driven by the driver circuit 2 to emit light at the third luminance based on the third subpixel driving data when the subpixel 10 is turned on by the third PWM signal (sub-step S243). Since the grayscale value falls within the third grayscale range, the leftmost (M+N+P) bits of the reference binary code are all binary 0, and thus the third pulse width code, which is 2^{(M+N+P)} times the reference binary code, can be obtained by simply shifting the other bits of the reference binary code to the left by (M+N+P) bit positions, thereby minimizing the complexity of circuit design. In this implementation, when the grayscale value falls within the third grayscale range, the adverse effects resulting from the distortions at rising and falling edges of the PWM signal can be further alleviated because the pulse width is increased to 2^{(M+N+P)} times the reference pulse width, while the diminished luminance (i.e., the third luminance that is 2^{-(N+P)} times the first luminance) further reduces harm caused to the eyes of the viewer. Furthermore, since all of the first PWM, the second PWM and the third PWM use the same predetermined relationship between grayscale and pulse width for PWM, required memory capacity can be minimized. In the example as shown in FIGS. 5, M=0, N=1, and P=1, so the second luminance is half the first luminance, and the third luminance is half the second luminance.

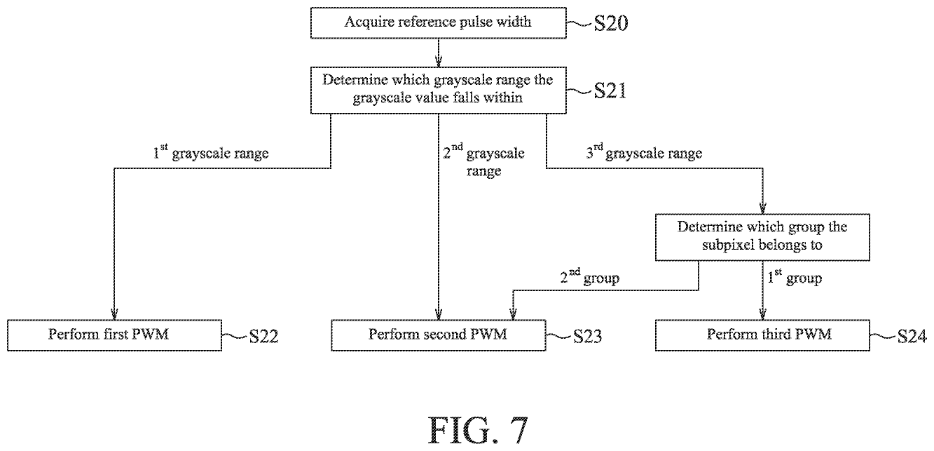

In practice, because of uncertainties in manufacturing processes, the subpixels 10 may have different optoelectronic properties. For example, different subpixels 10 may need different driving voltages to achieve the same luminance. Therefore, the driver circuit 2 may struggle to generate suitable voltages or currents for those of the subpixels 10 with optoelectronic properties that deviate from an expected range in a case of low luminance. During the production of the display screen, the production line may measure the optoelectronic properties of the subpixels 10, classify the subpixels 10 into several groups based on the optoelectronic properties of the subpixels 10, and store data of the classifications in a memory chip of the display screen. When receiving the grayscale value of a subpixel 10, the driver circuit 2 may determine which one of the groups the subpixel belongs to based on the data of the classifications, and then take the following actions accordingly. It is noted that the determination may be made before step S20, between steps S20 and S21, or after step S21, and this disclosure is not limited in this respect. Taking FIG. 4 as an example, it is assumed that a subpixel 10A is classified into a first group that is composed of those of the subpixels that are able to be driven by the driver circuit 2 to emit light at the third luminance, and it is assumed that a subpixel 10B is classified into a second group that is composed of those of the subpixels that are unable to be driven by the driver circuit 2 to emit light at the third luminance. Further referring to FIG. 7, which illustrates a variation of the flow chart as shown in FIG. 6, when the driver circuit 2 determines that the grayscale value of the subpixel 10 falls within the third grayscale range and that the subpixel 10 belongs to the first group (e.g., the subpixel 10A), the flow goes to step S24 to perform the third PWM on the subpixel 10. When the driver circuit 2 determines that the grayscale value of the subpixel 10 falls within the third grayscale range and that the subpixel 10 belongs to the second group (e.g., the subpixel 10B), the flow goes to step S23 to perform the second PWM on the subpixel 10. In one example, the third subpixel driving data, which is stored in the third subpixel driving memory unit 43, may include data for driving those subpixels 10 in the second group to emit light at the second luminance. Therefore, when determining that the grayscale value of the subpixel 10B falls within the third grayscale range and that the subpixel 10B belongs to the second group, the driver circuit 2 accesses the third subpixel driving memory unit 43 to obtain the third subpixel driving data, and performs the second PWM on the subpixel 10B based on the third subpixel driving data. In other words, the driver circuit 2 determines from which of the subpixel driving memory units to acquire data for driving the subpixel 10 based on which grayscale range the grayscale value falls within, regardless of whether the subpixel 10 being processed belongs to the first group or the second group, thereby achieving a simpler operation of the driver circuit 2. In another example, the third subpixel driving data do not include data for driving those subpixels 10 in the second group to emit light. Therefore, when determining that the grayscale value of the subpixel 10B falls within the third grayscale range and that the subpixel 10B belongs to the second group, the driver circuit 2 accesses the second subpixel driving memory unit 42 to obtain the second subpixel driving data, and performs the second PWM on the subpixel 10B based on the second subpixel driving data. Since a size of the third subpixel driving data is reduced, required memory capacity can be minimized.

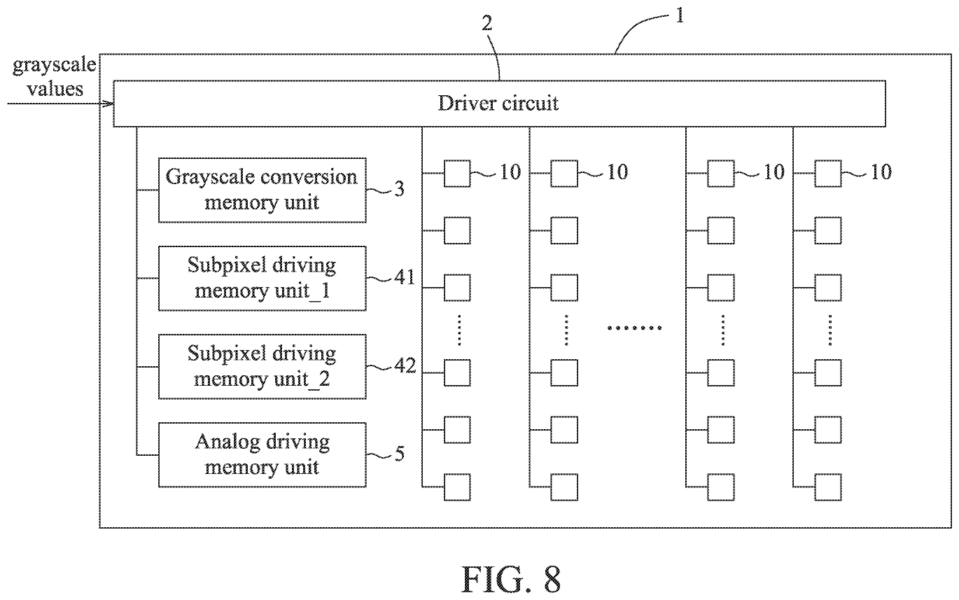

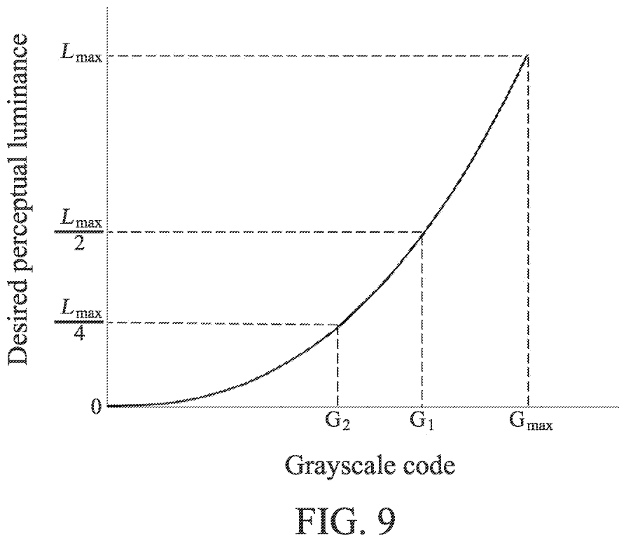

FIG. 8 illustrates a third implementation of the embodiment of the display screen that is similar to the first implementation. The third implementation differs from the first implementation in that the display screen of the third implementation further includes an analog driving memory unit 5, which can be realized using the memory chip(s) on the screen substrate 1. Further referring to FIG. 9, an exemplary relationship between grayscale and desired perceptual luminance is shown to be adapted to the third implementation. In this example, the first grayscale range is from (G₂+1) to G₁, the second grayscale range is from 0 to G₂, M=1, and N=1, so the first luminance is half the maximum desired perceptual luminance Lₘₐₓ, and the second luminance is half the first luminance. When the grayscale value of the subpixel 10 is greater than the upper limit of the first grayscale range (i.e., G₁ in FIG. 9), the driver circuit 2 performs analog driving on the subpixel 10. The analog driving memory unit 5 stores analog driving data that includes, for each of the subpixels 10, a plurality of data pieces such as voltage values or current values, each corresponding to a respective one of those of the grayscale codes that are greater than the upper limit of the first grayscale range, for driving the subpixel 10 to emit light at corresponding luminance that is greater than the first luminance. When determining that the grayscale value of the subpixel 10 is greater than the upper limit of the first grayscale range, the driver circuit 2 accesses the analog driving memory unit 5 to obtain the analog driving data, and drives the subpixel 10 to constantly emit light at a luminance that equals the desired perceptual luminance corresponding to the grayscale value. When the grayscale value of the subpixel 10 falls within the first grayscale range or the second grayscale range, the operation of the driver circuit 2 is the same as was described for the first implementation, so details thereof are not repeated herein for the sake of brevity.

It is noted that, in practice, the grayscale codes may be divided into more grayscale ranges that correspond to multiple different PWMs, respectively, but the driver circuit 2 can still implement the method of this disclosure according to the aforesaid concept and rules, so this disclosure is not limited to the examples introduced above.

In summary, the embodiment of the display screen according to this disclosure is able to display images using multiple different PWMs that respectively correspond to different grayscale ranges, and that increase the pulse width of the PWM signal when the grayscale value is small, while the subpixel emits light at lower luminance. The increased pulse width significantly alleviates the adverse effects resulting from the distortions at the rising edge and the falling edge of the PWM signal, thereby achieving a better displaying performance. Meanwhile, the subpixel emitting light at lower luminance during the PWM when the grayscale value is small may reduce the harm caused to human eyes.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for controlling subpixel luminance of a display screen, being implemented by a driver circuit on the display screen, and comprising:
receiving a grayscale value of a first subpixel of the display screen;
performing a first pulse width modulation (PWM) on the first subpixel based on the grayscale value when the grayscale value falls within a first grayscale range, where the first subpixel is driven to emit light at a first luminance when the first subpixel is turned on during the performing of the first PWM; and
performing a second PWM on the first subpixel based on the grayscale value when the grayscale value falls within a second grayscale range that is separate from and lower than the first grayscale range, where the first subpixel is driven to emit light at a second luminance when the first subpixel is turned on during the performing of the second PWM, and the second luminance is 2^{-N} times the first luminance, N being a positive integer.

2. The method as claimed in claim 1, further comprising:
acquiring a reference pulse width based on the grayscale value and a predetermined relationship between grayscale and pulse width for PWM;
wherein the performing the first PWM on the first subpixel includes sending a first PWM signal that has a pulse width equaling 2^{M} times the reference pulse width to the first subpixel to control dimming of the first subpixel, where M is an integer not smaller than zero; and
wherein the performing the second PWM on the first subpixel includes sending a second PWM signal that has a pulse width equaling 2^{(M+N)} times the reference pulse width to the first subpixel to control dimming of the first subpixel.

3. The method as claimed in claim 2, wherein the acquiring the reference pulse width comprises mapping the grayscale value to a reference binary code using the predetermined relationship between grayscale and pulse width for PWM, and the reference pulse width corresponds to the reference binary code, which is composed of a plurality of bits;
wherein, when the grayscale value falls within the first grayscale range, each of the leftmost M number of bit(s) of the reference binary code is equal to binary 0; and
wherein, when the grayscale value falls within the second grayscale range, each of the leftmost (M+N) number of bit(s) of the reference binary code is equal to binary 0.

4. The method as claimed in claim 3, wherein performing the first PWM on the first subpixel comprises:
performing a left shift by M bit position(s) on the reference binary code to obtain a first pulse width code; and
generating the first PWM signal of which the pulse width corresponds to the first pulse width code; and
wherein performing the second PWM on the first subpixel comprises:
performing a left shift by (M+N) bit position(s) on the reference binary code to obtain a second pulse width code; and
generating the second PWM signal of which the pulse width corresponds to the second pulse width code.

5. The method as claimed in claim 4, wherein, when the grayscale value is equal to an upper limit of the first grayscale range, each of the bits other than the leftmost M number of bit(s) of the reference binary code is equal to binary 1; and
wherein, when the grayscale value is equal to an upper limit of the second grayscale range, each of the bits other than the leftmost (M+N) number of bit(s) of the reference binary code is equal to binary 1.

6. The method as claimed in claim 1, further comprising:
performing a third PWM on the first subpixel based on the grayscale value of the first subpixel when the grayscale value of the first subpixel falls within a third grayscale range that is separate from and lower than the second grayscale range, where the first subpixel is driven to emit light at a third luminance when the first subpixel is turned on during the performing of the third PWM, and the third luminance is 2^{-P} times the second luminance, P being a positive integer;
receiving a grayscale value of a second subpixel of the display screen;
performing the first PWM on the second subpixel based on the grayscale value of the second subpixel when the grayscale value of the second subpixel falls within the first grayscale range, where the second subpixel is driven to emit light at the first luminance when the second subpixel is turned on during the performing of the first PWM; and
performing the second PWM on the second subpixel based on the grayscale value of the second subpixel when the grayscale value of the second subpixel falls within any one of the second grayscale range and the third grayscale range, where the second subpixel is driven to emit light at the second luminance when the second subpixel is turned on during the performing of the second PWM.

7. The method as claimed in claim 6, further comprising:
acquiring a first reference pulse width for the first subpixel based on the grayscale value of the first subpixel and a predetermined relationship between grayscale and pulse width for PWM; and
acquiring a second reference pulse width for the second subpixel based on the grayscale value of the second subpixel and the predetermined relationship between grayscale and pulse width for PWM;
wherein performing the first PWM on the first subpixel includes sending a first PWM signal that has a pulse width equaling 2^{M} times the first reference pulse width to control dimming of the first subpixel, where M is an integer not smaller than zero;
wherein performing the second PWM on the first subpixel includes sending a second PWM signal that has a pulse width equaling 2^{(M+N)} times the first reference pulse width to control dimming of the first subpixel;
wherein performing the third PWM on the first subpixel includes sending a third PWM signal that has a pulse width equaling 2^{(M+N+P)} times the first reference pulse width to control dimming of the first subpixel;
wherein performing the first PWM on the second subpixel includes sending a fourth PWM signal that has a pulse width equaling 2^{M} times the second reference pulse width to control dimming of the second subpixel; and
wherein performing the second PWM on the second subpixel includes sending a fifth PWM signal that has a pulse width equaling 2^{(M+N)} times the second reference pulse width to control dimming of the second subpixel.

8. The method as claimed in claim 1, further comprising:
driving the first subpixel to constantly emit light at a luminance that corresponds to the grayscale value and that is greater than the first luminance when the grayscale value is greater than an upper limit of the first grayscale range.

9. A display screen, comprising:
a screen substrate formed with a plurality of subpixels, one of which is a first subpixel;
a first subpixel driving memory unit mounted on said screen substrate, and storing first subpixel driving data that include a datum for driving said first subpixel to emit light at a first luminance;
a second subpixel driving memory unit mounted on said screen substrate, and storing second subpixel driving data that include a datum for driving said first subpixel to emit light at a second luminance that is 2^{-N} times the first luminance, N being a positive integer;
a grayscale conversion memory unit mounted on said screen substrate, and storing a predetermined relationship between grayscale and pulse width for pulse width modulation (PWM); and
a driver circuit mounted on said screen substrate, electrically connected to said subpixels, said first subpixel driving memory unit, said second subpixel driving memory unit and said grayscale conversion memory unit, and disposed to receive a grayscale value of said first subpixel;
wherein said driver circuit is configured to, when the grayscale value falls within a first grayscale range, perform a first PWM on said first subpixel based on the grayscale value and the predetermined relationship between grayscale and pulse width for PWM, where said first subpixel is driven by said driver circuit to emit light at the first luminance based on the first subpixel driving data when said first subpixel is turned on during the performing of the first PWM; and
wherein said driver circuit is configured to, when the grayscale value falls within a second grayscale range that is separate from and lower than the first grayscale range, perform a second PWM on said first subpixel based on the grayscale value and the predetermined relationship between grayscale and pulse width for PWM, where said first subpixel is driven by said driver circuit to emit light at the second luminance based on the second subpixel driving data when said first subpixel is turned on during the performing of the second PWM.

10. The display screen as claimed in claim 9, wherein said driver circuit is configured to acquire a reference pulse width based on the grayscale value and the predetermined relationship between grayscale and pulse width for PWM;
wherein said driver circuit is configured to, when performing the first PWM on said first subpixel, send a first PWM signal that has a pulse width equaling 2^{M} times the reference pulse width to control dimming of said first subpixel, where M is an integer not smaller than zero; and
wherein said driver circuit is configured to, when performing the second PWM on said first subpixel, send a second PWM signal that has a pulse width equaling 2^{(M+N)} times the reference pulse width to control dimming of said first subpixel.

11. The display screen as claimed in claim 10, wherein said driver circuit is configured to, when acquiring the reference pulse width, map the grayscale value to a reference binary code using the predetermined relationship between grayscale and pulse width for PWM, and the reference pulse width corresponds to the reference binary code, which is composed of a plurality of bits;
wherein, when the grayscale value falls within the first grayscale range, each of the leftmost M number of bit(s) of the reference binary code is equal to binary 0; and
wherein, when the grayscale value falls within the second grayscale range, each of the leftmost (M+N) number of bit(s) of the reference binary code is equal to binary 0.

12. The display screen as claimed in claim 11, wherein said driver circuit is configured to, when performing the first PWM on said first subpixel,
perform a left shift by M bit position(s) on the reference binary code to obtain a first pulse width code, and
generate the first PWM signal of which the pulse width corresponds to the first pulse width code; and
wherein said driver circuit is configured to, when performing the second PWM on said first subpixel,
perform a left shift by (M+N) bit position(s) on the reference binary code to obtain a second pulse width code, and
generate the second PWM signal of which the pulse width corresponds to the second pulse width code.

13. The display screen as claimed in claim 12, wherein, when the grayscale value is equal to an upper limit of the first grayscale range, each of the bits other than the leftmost M number of bit(s) of the reference binary code is equal to binary 1; and
wherein, when the grayscale value is equal to an upper limit of the second grayscale range, each of the bits other than the leftmost (M+N) number of bit(s) of the reference binary code is equal to binary 1.

14. The display screen as claimed in claim 9, further comprising a third subpixel driving memory unit mounted on said screen substrate, electrically connected to said driver circuit, and storing third subpixel driving data that include a datum for driving said first subpixel to emit light at a third luminance that is 2^{-P} times the second luminance and a datum for driving a second subpixel, which is another one of said subpixels, to emit light at the second luminance, where P is a positive integer;
wherein the first subpixel driving data further include a datum for driving said second subpixel to emit light at the first luminance, and the second subpixel driving data further include a datum for driving said second subpixel to emit light at the second luminance;
wherein said driver circuit is configured to, when the grayscale value of said first subpixel falls within a third grayscale range that is separate from and lower than the second grayscale range, perform a third PWM on said first subpixel based on the grayscale value of said first subpixel and the predetermined relationship between grayscale and pulse width for PWM, where said first subpixel is driven by said driver circuit based on the third subpixel driving data to emit light at the third luminance when said first subpixel is turned on during the performing of the third PWM;
wherein said driver circuit is configured to receive a grayscale value of said second subpixel of said display screen;
wherein said driver circuit is configured to, when the grayscale value of said second subpixel falls within the first grayscale range, perform the first PWM on said second subpixel based on the grayscale value of said second subpixel and the predetermined relationship between grayscale and pulse width for PWM, where said second subpixel is driven to emit light at the first luminance based on the first subpixel driving data when said second subpixel is turned on during the performing of the first PWM;
wherein said driver circuit is configured to, when the grayscale value of said second subpixel falls within the second grayscale range, perform the second PWM on said second subpixel based on the grayscale value of said second subpixel and the predetermined relationship between grayscale and pulse width for PWM, where said second subpixel is driven to emit light at the second luminance based on the second subpixel driving data when said second subpixel is turned on during the performing of the second PWM; and
wherein said driver circuit is configured to, when the grayscale value of said second subpixel falls within the third grayscale range, perform the second PWM on said second subpixel based on the grayscale value of said second subpixel and the predetermined relationship between grayscale and pulse width for PWM, where said second subpixel is driven to emit light at the second luminance based on the third subpixel driving data when said second subpixel is turned on during the performing of the second PWM.

15. The display screen as claimed in claim 14, wherein said driver circuit is configured to acquire a first reference pulse width for said first subpixel based on the grayscale value of said first subpixel and the predetermined relationship between grayscale and pulse width for PWM, and to acquire a second reference pulse width for said second subpixel based on the grayscale value of said second subpixel and the predetermined relationship between grayscale and pulse width for PWM;
wherein said driver circuit is configured to, when performing the first PWM on said first subpixel, send a first PWM signal that has a pulse width equaling 2 times the first reference pulse width to control dimming of said first subpixel, where M is an integer not smaller than zero;
wherein said driver circuit is configured to, when performing the second PWM on said first subpixel, send a second PWM signal that has a pulse width equaling 2^{(M+N)} times the first reference pulse width to control dimming of said first subpixel;
wherein said driver circuit is configured to, when performing the third PWM on said first subpixel, send a third PWM signal that has a pulse width equaling 2^{(M+N+P)} times the first reference pulse width to control dimming of said first subpixel;
wherein said driver circuit is configured to, when performing the first PWM on said second subpixel, send a fourth PWM signal that has a pulse width equaling 2^{M} times the second reference pulse width to control dimming of said second subpixel; and
wherein said driver circuit is configured to, when performing the second PWM on said second subpixel, send a fifth PWM signal that has a pulse width equaling 2^{(M+N)} times the second reference pulse width to control dimming of said second subpixel.

16. The display screen as claimed in claim 9, further comprising a third subpixel driving memory unit mounted on said screen substrate, electrically connected to said driver circuit, and storing third subpixel driving data that include a datum for driving the first subpixel to emit light at a third luminance that is 2^{-P} times the second luminance, where P is a positive integer;
wherein said driver circuit is configured to, when the grayscale value of said first subpixel falls within a third grayscale range that is separate from and lower than the second grayscale range, perform a third PWM on said first subpixel based on the grayscale value of said first subpixel and the predetermined relationship between grayscale and pulse width for PWM, where said first subpixel is driven by said driver circuit based on the third subpixel driving data to emit light at the third luminance when said first subpixel is turned on during the performing of the third PWM;
wherein said driver circuit is configured to receive a grayscale value of a second subpixel, which is another one of said subpixels of said display screen;
wherein the first subpixel driving data further include a datum for driving said second subpixel to emit light at the first luminance, and the second subpixel driving data further include a datum for driving said second subpixel to emit light at the second luminance;
wherein said driver circuit is configured to, when the grayscale value of said second subpixel falls within the first grayscale range, perform the first PWM on said second subpixel based on the grayscale value of said second subpixel and the predetermined relationship between grayscale and pulse width for PWM, where said second subpixel is driven to emit light at the first luminance based on the first subpixel driving data when said second subpixel is turned on during the performing of the first PWM; and
wherein said driver circuit is configured to, when the grayscale value of said second subpixel falls within any one of the second grayscale range and the third grayscale range, perform the second PWM on said second subpixel based on the grayscale value of said second subpixel and the predetermined relationship between grayscale and pulse width for PWM, where said second subpixel is driven to emit light at the second luminance based on the second subpixel driving data when said second subpixel is turned on during the performing of the second PWM.

17. The display screen as claimed in claim 16, wherein said driver circuit is configured to acquire a first reference pulse width for said first subpixel based on the grayscale value of said first subpixel and the predetermined relationship between grayscale and pulse width for PWM, and to acquire a second reference pulse width for said second subpixel based on the grayscale value of said second subpixel and the predetermined relationship between grayscale and pulse width for PWM;
wherein said driver circuit is configured to, when performing the first PWM on said first subpixel, send a first PWM signal that has a pulse width equaling 2^{M} times the first reference pulse width to control dimming of said first subpixel, where M is an integer not smaller than zero;
wherein said driver circuit is configured to, when performing the second PWM on said first subpixel, send a second PWM signal that has a pulse width equaling 2^{(M+N)} times the first reference pulse width to control dimming of said first subpixel;
wherein said driver circuit is configured to, when performing the third PWM on said first subpixel, send a third PWM signal that has a pulse width equaling 2^{(M+N+P)} times the first reference pulse width to control dimming of said first subpixel;
wherein said driver circuit is configured to, when performing the first PWM on said second subpixel, send a fourth PWM signal that has a pulse width equaling 2^{M} times the second reference pulse width to control dimming of said second subpixel; and
wherein said driver circuit is configured to, when performing the second PWM on said second subpixel, send a fifth PWM signal that has a pulse width equaling 2^{(M+N)} times the second reference pulse width to control dimming of said second subpixel.

18. The display screen as claimed in claim 9, wherein said driver circuit is configured to drive said first subpixel to constantly emit light at a luminance that corresponds to the grayscale value and that is greater than the first luminance when the grayscale value is greater than an upper limit of the first grayscale range.
